(19) United States
(12) Patent Application Publication
(10) Pub. No.: US 2012/0216348 A1
(43) Pub. Date: Aug. 30, 2012

(54) ACCESSORY BAR FOR A TREATMENT BED

(76) Inventor: Larry E. Cox, Charlevoix, MI (US)

(21) Appl. No.: 13/505,135

(22) PCT Filed: Oct. 30, 2009
(86) PCT No.: PCT/US09/62690

§ 371 Date: Apr. 30, 2012

(51) Int. Cl. A61G 13/10; A47C 21/04; A47C 21/00

(52) U.S. Cl. 5/421; 5/503.1

(57) ABSTRACT

An accessory bar for a treatment bed is disclosed. The bar comprises a bracket releasably mounted, in use, to said treatment bed. An upright extends upwardly from the bracket in use. In one embodiment, an aim extends transversely from the upright. The aim has extending therefrom one or more pairs of posts. The posts extend generally horizontally, towards the area over the bed, in use.

### FIELD OF THE INVENTION

The present invention relates to the field of personal wellness.

### BACKGROUND OF THE INVENTION

Thermal (infrared) massage, as a tool to enhance personal wellness and immune function, is gaining consumer acceptance worldwide. As a result of this increased awareness and acceptance, a plurality of specialized tools are reaching the marketplace. One type of tool that has reached the marketplace is a treatment system which includes a treatment bed, first and second treatment appliances, a treatment mat and first and second remote control units. The treatment bed has a main body pad, a lower body pad, a bed frame and a pair of grips. The main body pad is for supporting and selectively applying heat and massage to the main (upper) body of a user in the supine or prone position. The lower body pad is for supporting and selectively applying heat and massage to the lower body of the user. The bed frame is for supporting the main body pad and the lower body pad in use. The grips are bolted on opposite sides of the frame and are for assisting the user in movement to and from the supine and prone positions on the treatment bed. The first and second treatment appliances are for placement against a selected body region and selectively applying heat and point pressure thereto. Each appliance includes a waisted portion and the second appliance is larger than the first. The treatment mat has a hand-grip and is for producing far infrared radiation and negative ions. The first remote control unit is for controlling the first and second treatment appliances and the main and lower body pads. The second remote control unit is for controlling the mat and has a socket defined therein.

### SUMMARY OF THE INVENTION

Apparatus for use with a treatment system forms one aspect of the invention. The treatment system is of the type including a treatment bed, first and second treatment appliances, a treatment mat and first and second remote control units. The treatment bed has: one or more cushions for supporting a user in the supine or prone position; a bed frame supporting the one or more cushions in use; a pair of grips, bolted on opposite sides of the bed frame, for assisting the user in movement to and from the supine and prone positions; and a cradle, releasably mounted to the bed frame. The first and second treatment appliances each include a waisted portion. The treatment mat has a hand-grip. The first remote control unit is for controlling the first and second treatment appliances and adapted to be releasably received by the cradle. The second remote control unit is for controlling the treatment mat and has a socket defined therein. The apparatus comprises a support frame, for, in use, releasably receiving and supporting in elevated relation above and to one side of the treatment bed, one or more of: the first treatment appliance, the second treatment appliance, the treatment mat, the first remote control unit, the second remote control unit, the cradle and a video monitor.

According to another aspect of the invention, the support frame can be adapted for, in use, releasably receiving and supporting in elevated relation above and to one side of the treatment bed: the first treatment appliance, the second treatment, the treatment mat, the first remote control unit, the second remote control unit and the cradle.

According to another aspect of the invention, the support frame can include an upright having an arm extending laterally therefrom, the arm having: for each appliance, a pair of protruding posts, the posts of each pair being spaced apart for releasably receiving therebetween the waisted portions of said each appliance, to provide for said releasable receipt of said each appliance.

According to another aspect of the invention, the support arm can include a bore to provide for said releasable receipt of the cradle.

According to another aspect of the invention, the support arm can further include a pin for receiving the socket of the second remote control unit, to provide for said releasable receipt of the second remote control unit.

According to another aspect of the invention, the upright can form part of crook, the crook terminating in a hook for receiving the hand-grip of the treatment mat, to provide for said releasable receipt of the treatment mat.

According to another aspect of the invention, the crook, the upright and the arm can be substantially coplanar, with the hook and the arm lying on opposite sides of the upright.

According to another aspect of the invention, the support frame can be releasably secured to the bed frame in use.

According to another aspect of the invention, the support frame can be bolted to the bed frame in use and one or more of the bolts bolting the support frame to the bed frame can form part of the bolts by which the grips are mounted to the bed frame.

Apparatus for use with a treatment system forms another aspect of the invention. This treatment system is of the type including a treatment bed, first and second treatment appliances, a treatment mat and first and second remote control units. The treatment bed has: a main body cushion for supporting and selectively applying heat and massage to the upper body of a user in the supine or prone position; a lower body cushion for supporting and selectively applying heat and massage to the lower body of the user; a bed frame supporting the main body cushion and the lower body cushion in use; a pair of grips, bolted on opposite sides of the bed frame, for assisting the user in movement to and from the supine and prone positions; and a cradle, releasably mounted to the frame. The first and second treatment appliances are each for placement against a selected body region and selectively applying heat and point pressure thereto and each includes a waisted portion. The treatment mat has a hand-grip and is adapted for producing far infrared radiation and negative ions. The first remote control unit is for controlling the first and second treatment appliances and the main and lower body cushions and is adapted to be releasably received by the cradle. The second remote control unit is for controlling the treatment mat and has a socket defined therein.

This apparatus comprises: a support frame, for, in use, releasably receiving and supporting in elevated relation above and to one side of the treatment bed, one or more of: the first treatment appliance, the second treatment appliance, the treatment mat, the first remote control unit, the second remote control unit, the cradle and a video monitor.
Forming another aspect of the invention is, in combination:
   a treatment bed having: one or more cushions for supporting a user in the supine or prone position; and a bed frame supporting the one or more cushions in use; and
   a support frame releasably connected, in use, to the treatment bed, and adapted for releasably receiving and supporting in elevated relation above and to one side of the treatment bed, one or more of:
      a diagnostic device;
      an energetic medical device;
      a remote control;
      a credit card reader; and
      a video monitor.

As yet other aspects of the invention:
the treatment bed can have a pair of grips, bolted on opposite sides of the bed frame, for assisting the user in movement to and from the supine and prone positions; and
the support frame can be bolted to the bed frame in use and one or more of the bolts bolting the support frame to the bed frame can form part of the bolts by which the grips are mounted to the bed frame.

As yet other aspects of the invention: (i) the combination can further comprise an energetic medical device having a waisted portion; and (ii) the support frame can be adapted for receiving said energetic medical device and include an upright and, for said energetic medical device, a pair of horizontally extending posts adapted to receive therebetween the waisted portion of said energetic medical device, thereby to provide for said releasably receipt of said energetic medical device.

According to another aspect of the invention, the upright can have an arm extending laterally therefrom and from which the posts protrude.

According to another aspect of the invention, the energetic medical device can be for placement against a selected body region and selectively applying far-infrared radiation and point pressure thereto.

According to another aspect of the invention, (i) the combination can further comprise an energetic medical device having a hand-grip; (ii) the support frame can be adapted for receiving said energetic medical device and (iii) the upright can form part of crook, the crook terminating in a hook for receiving the hand-grip of the energetic medical device, to provide for said releasable receipt of said energetic medical device.

According to another aspect of the invention, the energetic medical device can be a treatment mat adapted to produce far infrared radiation and negative ions.

According to another aspect of the invention, the crook, the upright and the arm can be substantially coplanar, with the hook and the arm lying on opposite sides of the upright.

An accessory bar for a treatment bed forms another aspect of the invention. The bar comprises: a bracket releasably mounted, in use, to said treatment bed; an upright extending upwardly from the bracket in use; and an arm extending transversely from the upright, the arm having extending therefrom one or more pairs of posts, the posts extending generally horizontally, towards the area over the bed, in use.

According to another aspect of the invention, the upright can form part of crook, the crook terminating in a hook, the crook, the upright and the arm being substantially coplanar, with the hook and the arm lying on opposite sides of the upright.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinafter.

### BRIEF DESCRIPTION OF THE DRAWINGS

FIG. 1 shows a prior art treatment system;

FIG. 2 shows apparatus according to an exemplary embodiment of the present invention;

FIG. 3 shows the apparatus of FIG. 2 in use with part of the structure of FIG. 1;

FIG. 4 is a partial view of the apparatus of FIG. 2 in use with another part of the structure of FIG. 1;

FIG. 5 is a view of the apparatus of FIG. 2 in use with the structure of FIG. 1;

FIG. 6 is a view of apparatus according to another exemplary embodiment of the present invention;

FIG. 7 is a view of apparatus according to yet another exemplary embodiment of the present invention;

FIG. 8 is a view of apparatus according to yet another exemplary embodiment of the present invention in use;

FIG. 9 is a view similar to FIG. 3 but showing apparatus according to yet another exemplary embodiment of the present invention; and

FIG. 10 is a view similar to FIG. 3 but showing apparatus according to yet another exemplary embodiment of the present invention.

### DETAILED DESCRIPTION

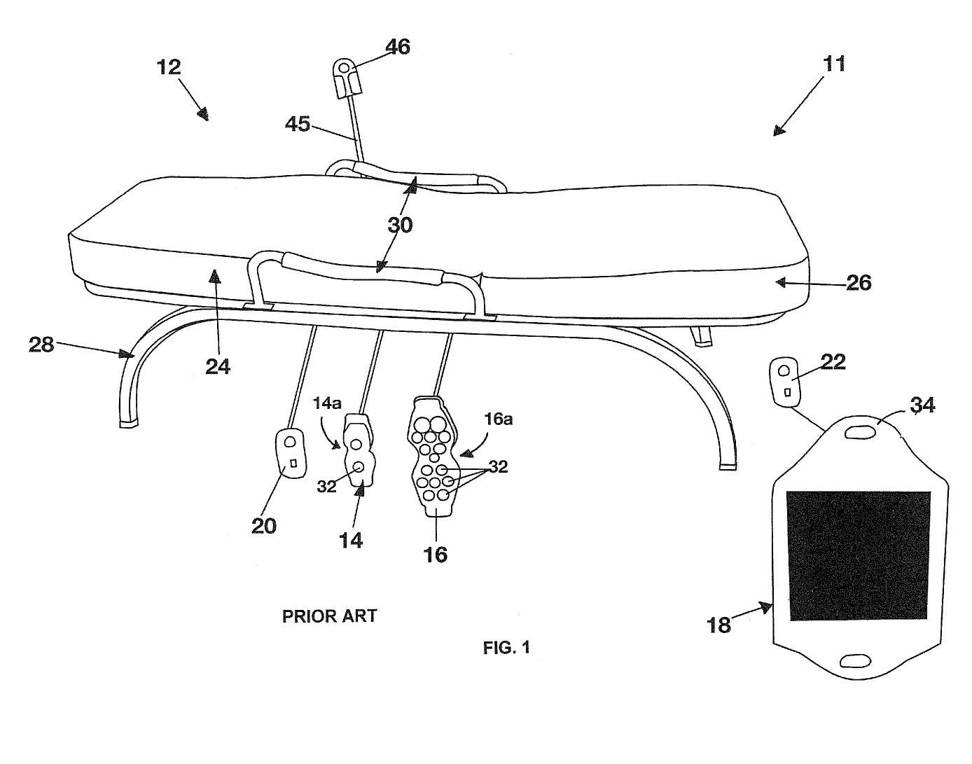

The present invention relates to the field of wellness and, in an exemplary embodiment, relates to a treatment system. For clarity in the description of the invention, a prior art treatment system 11, with which the invention can be used but which forms no part of the invention, will firstly be described with reference to FIG. 1.

The treatment system 11 is of the type including a treatment bed 12, first 14 and second 16 treatment appliances, a treatment mat 18 and first 20 and second 22 remote control units. The treatment bed 12, first 14 and second 16 treatment appliances and first remote control unit 14 are sold by Migun Medical Instrument Co. under Model No. HY-7000 UM. The treatment mat 18 and the second remote control unit 22 are sold by Migun Medical Instrument Co. under Model No. MG-3600.

The treatment bed 12 has a main body cushion 24, a lower body cushion 26, a bed frame 28, a pair of grips 30 and a cradle 46.

The main body cushion 24 is for supporting and selectively applying heat and massage to upper body of a user in the supine or prone position on the treatment bed. The lower body cushion 26 is for supporting and selectively applying heat and massage to the lower body of the user. For the purpose of applying heat and massage, each of the main body 24 and lower body 26 cushions includes devices for producing far infrared radiation, and well as vibrators.

The bed frame 28 is for supporting the main body cushion 24 and the lower body cushion 26 in use and is formed out of tubular elements, bolted together.

The grips 30 are bolted on opposite sides of the frame 28 and are for assisting the user in movement to and from the supine and prone positions on the bed 12.

The first 14 and second 16 treatment appliances are for placement against a selected body region and selectively applying heat and point pressure thereto. Each appliance includes a waisted portion 14A, 16A and the second appliance 16 is larger than the first appliance 14. For the purpose of applying heat each of these appliances 14, 16 includes a device for producing far infrared radiation.

For the purpose of applying point pressure, each of these devices includes hard surfaces, specifically, jade stones 32. The first device 14 includes two stones 32, and the second device 16 includes 15 stones.

The cradle 46 is releasably mounted to the frame 28 via an intermediate flexible shaft 45 having a threaded bore at its end (not shown) and releasably receives the first remote control unit 20, discussed below, when not in use. To releasably mount the cradle 46 to the frame 28, a bolt (not shown) passes through a bore (not shown) in the frame 28 and threads into the threaded bore at the end of shaft 45, to secure the shaft 45 to the frame 28.

The treatment mat 18 has a hand-grip 34 and is adapted to produce far infrared radiation, for heating purposes, as well as negative ions.

The first remote control unit 20 is for controlling the first 14 and second 16 treatment appliances and the main 24 and lower 26 body cushions.

The second remote control unit 22 is for controlling the treatment mat 18 and has a socket (not shown) defined therein.

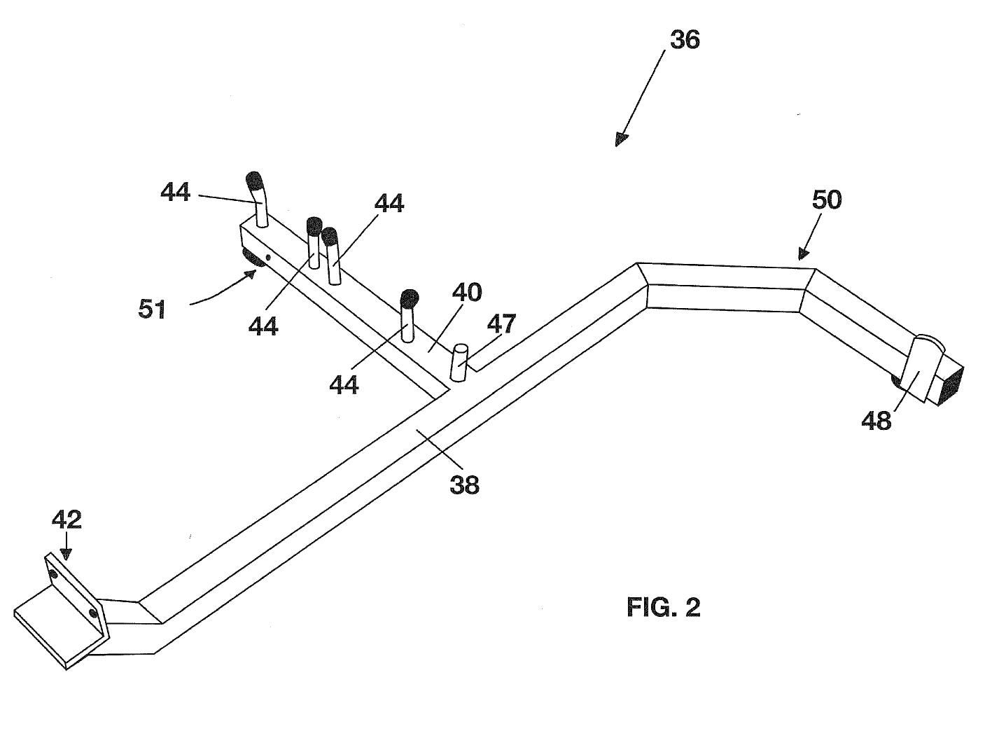

Turning now to the apparatus of the present invention, same will be seen in isolation in FIG. 2 and will be seen to comprise a support frame 36 which includes an upright 38, an arm 40, a bracket 42, posts 44, pin 47 and a hook 48. The upright 38 forms part of a crook 50. The arm 40 extends transversely from the upright 38 and has pin 47 extending therefrom and a bore 51 defined therethrough. Bracket 42 is rigidly connected, by welding, to the base of the upright 38. Two pairs of posts 44 are provided, which protrude from the arm 40. The hook 48 defines the terminus of the crook 50. The crook 50, the upright 38 and the arm 40 are substantially coplanar, with the hook 48 and the arm 40 lying on opposite sides of the upright 38. At the base of the upright 38, immediately preceding the bracket 42, the upright 38 jogs slightly.

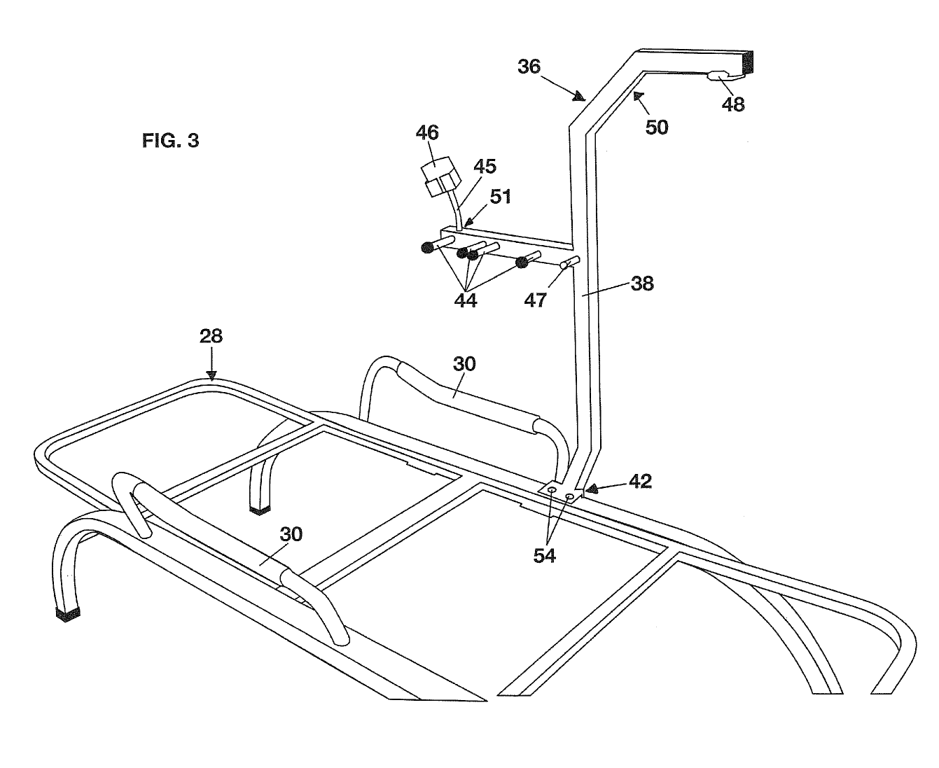

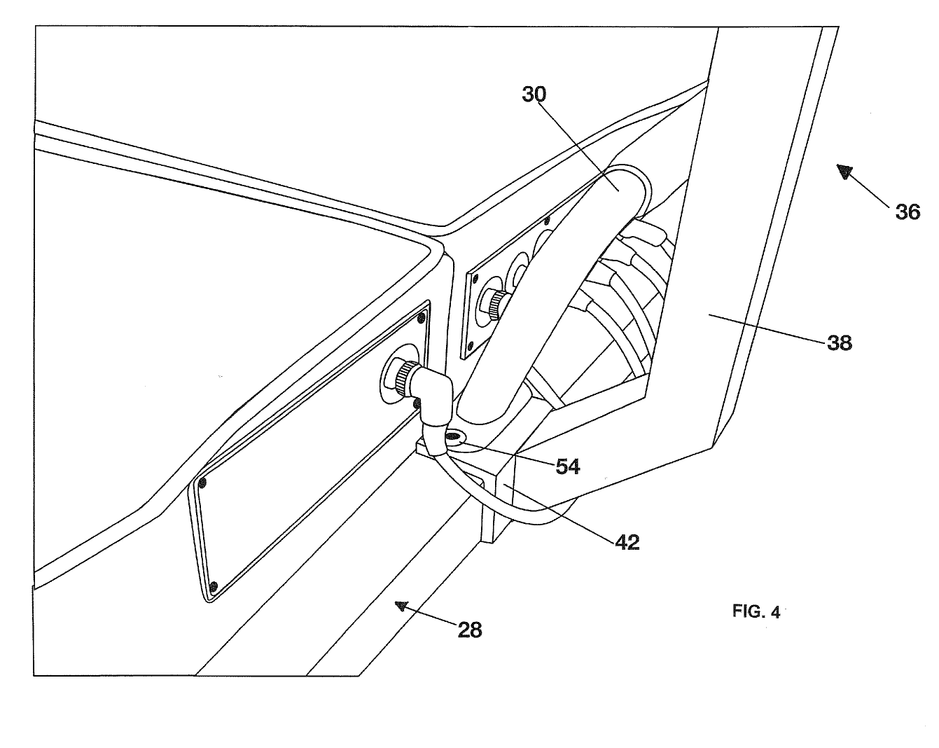

For use, the support frame 36 is releasably secured, specifically, by bolts 54, to the bed frame 28 in use, as shown in FIG. 3 and FIG. 4. More particularly, the support frame 36 is bolted to the bed frame 28 in use using the same bores as used to secure one of the grips 30, i.e. one or more of the bolts 54 bolting the support frame 36 to the bed frame 28 form part of the bolts by which the grips 30 are mounted to the bed frame 28. The bolt holding the flexible shaft 45 of the cradle 46 is also removed from the bed frame 28, to release shaft 45, and the bolt is fitted through bore 51 of the support frame, and thence back into the threaded bore in the shaft 45, to secure the shaft/cradle to the support frame.

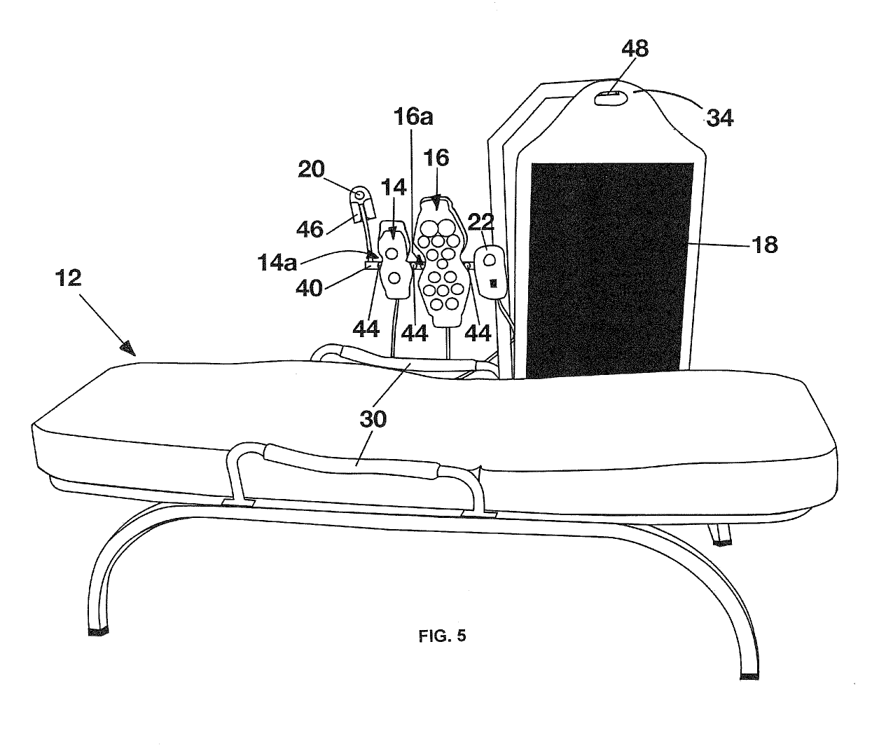

The apparatus is shown in use in FIG. 5. Herein, it will be seen that the apparatus is adapted to releasably receive and supporting in elevated relation, above and to one side of the treatment bed 12, each of the first 14 and second treatment 16 appliances, the treatment mat 18 and the first 20 and second 22 remote control units. More particularly, the waisted portions 14A, 16A of each appliance 14, 16 are releasably received between a respective pair of posts 44, the cradle 46 is in releasably receipt of the first remote control 20; the pin (not visible in FIG. 5) is in releasable receipt of the socket of the second remote control unit 22 and the hook 48 is in releasable receipt of the hand-grip 34 of the mat 18.

The apparatus will thus be seen to conveniently store all of the accessories associated with the treatment system, and thus is aptly described as an ‘accessory bar’. The accessory bar avoids damage/injury that might otherwise occur if the appliances/remote controls were simply left between use on the bed itself or the surrounding floor surface. As well, the bar keeps the appliances/controls in a location convenient for self-users, who might otherwise be required to lift them from the floor while on the bed, or hold onto them while mounting and dismounting the bed, adding to the potential for injury. The ‘jog’ in the upright, previously mentioned, ensures that the accessory bar and the accessories themselves, are disposed slightly to the side of the table, about 3″ from the edge of the cushions, so as not to interfere with ingress/egress.

Variations of this are, of course, possible.

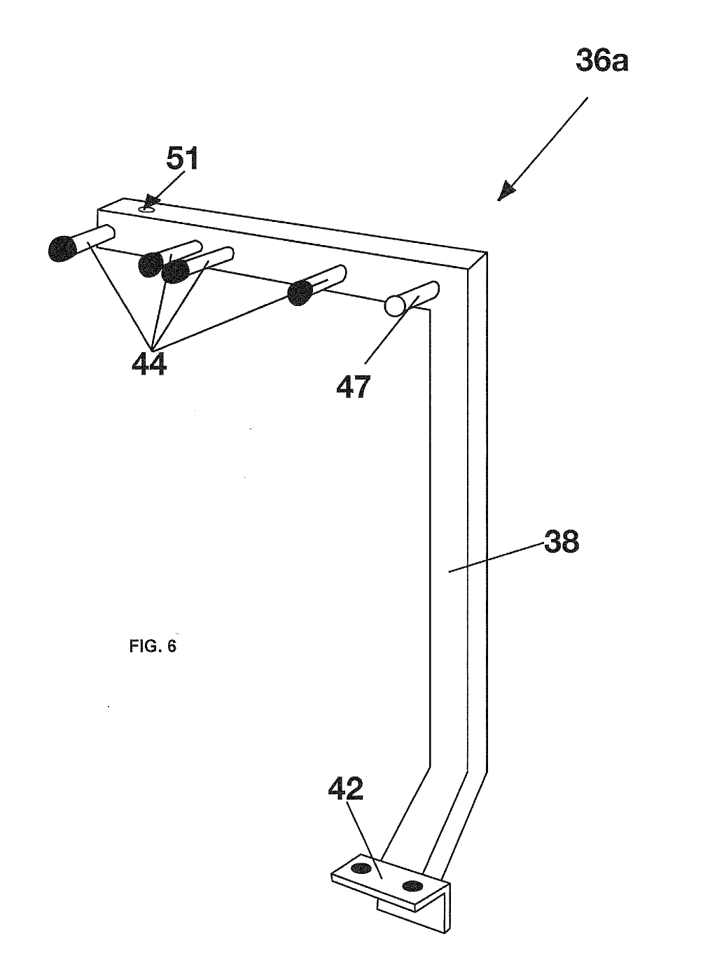

FIG. 6, for example, shows a variation 36A which does not include the hook/crook. This could be advantageous, as not all users will have use for and purchase the treatment mat.

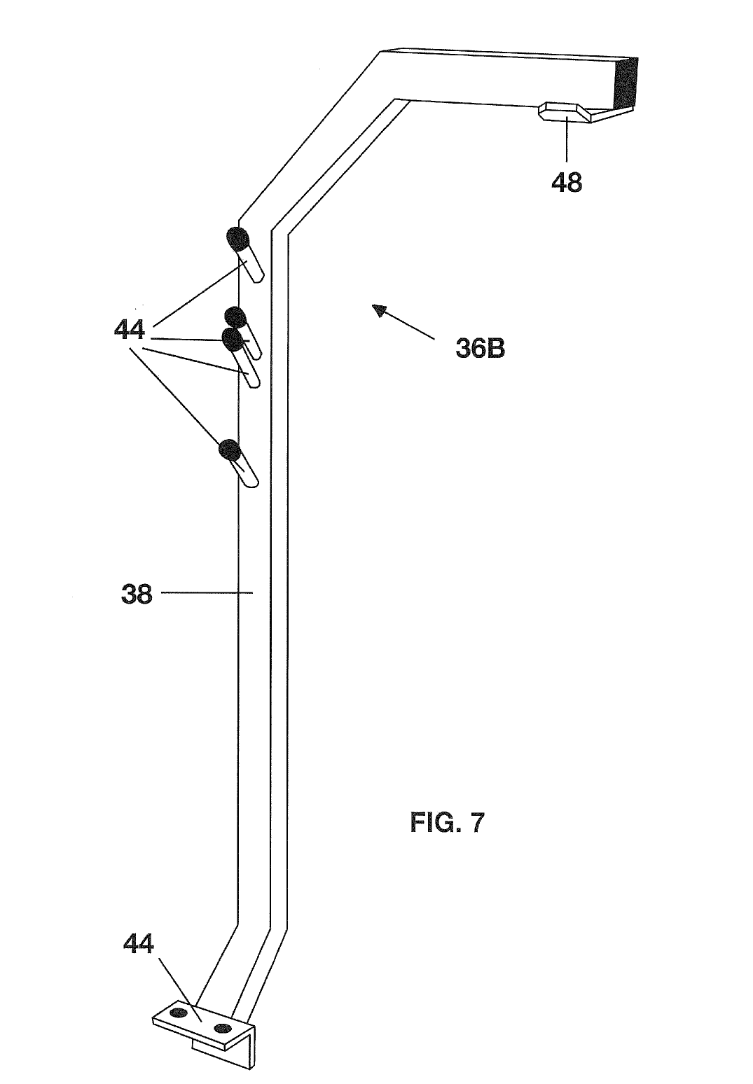

FIG. 7 shows another example 36B, wherein the posts protrude from the upright, i.e. with no transverse arm.

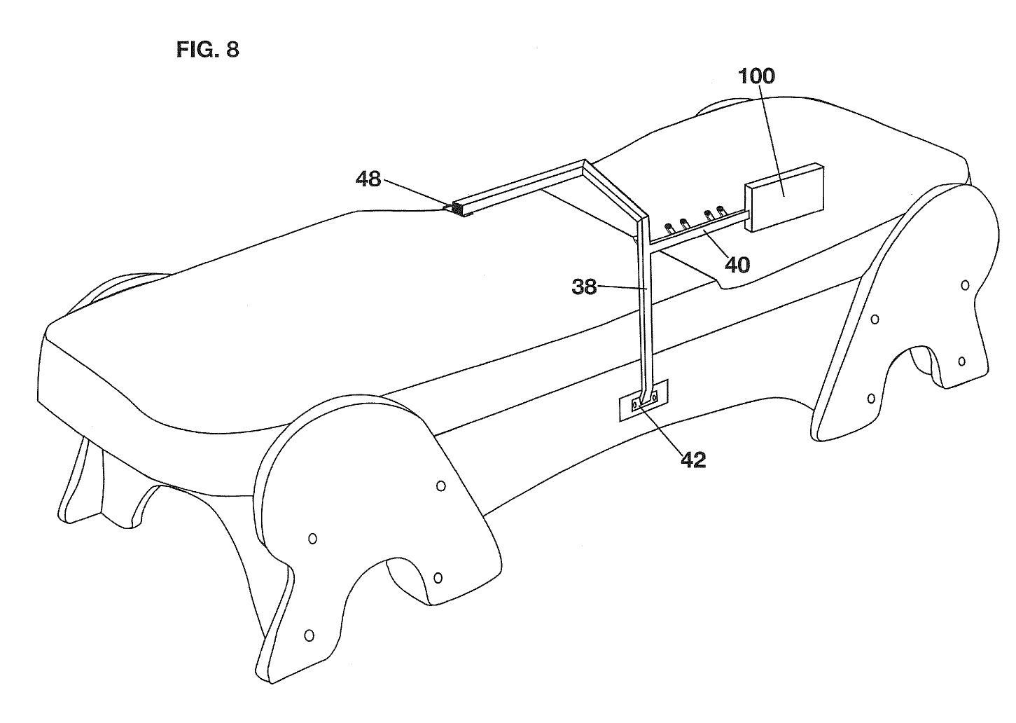

As well, whereas a specific model of treatment bed is illustrated and referenced, it will be understood that the support frame could be utilized with beds of other manufacturers and other styles. FIG. 8, for example, shows a variant of the mounting bracket mounted to a treatment bed of the type formed out of wood panels. Depending upon the treatment bed with which the support frame is used, suitable accommodation will need to be made, inter alfa, to the jog in the upright, to provide sufficient clearance to users, as will be evident to persons of ordinary skill in the art.

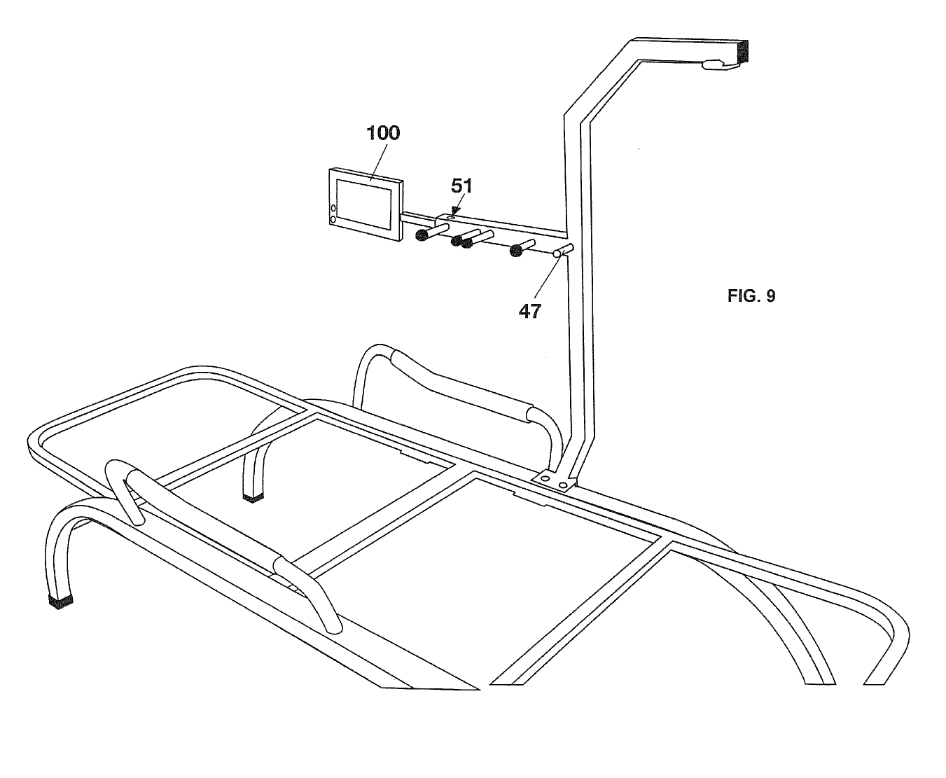

The support frame could also be adapted to receive a video monitor 100, as shown in FIG. 9. The monitor 100, which becomes easily viewable when mounted on the support frame, could be used advantageously for marketing and instructional purposes.

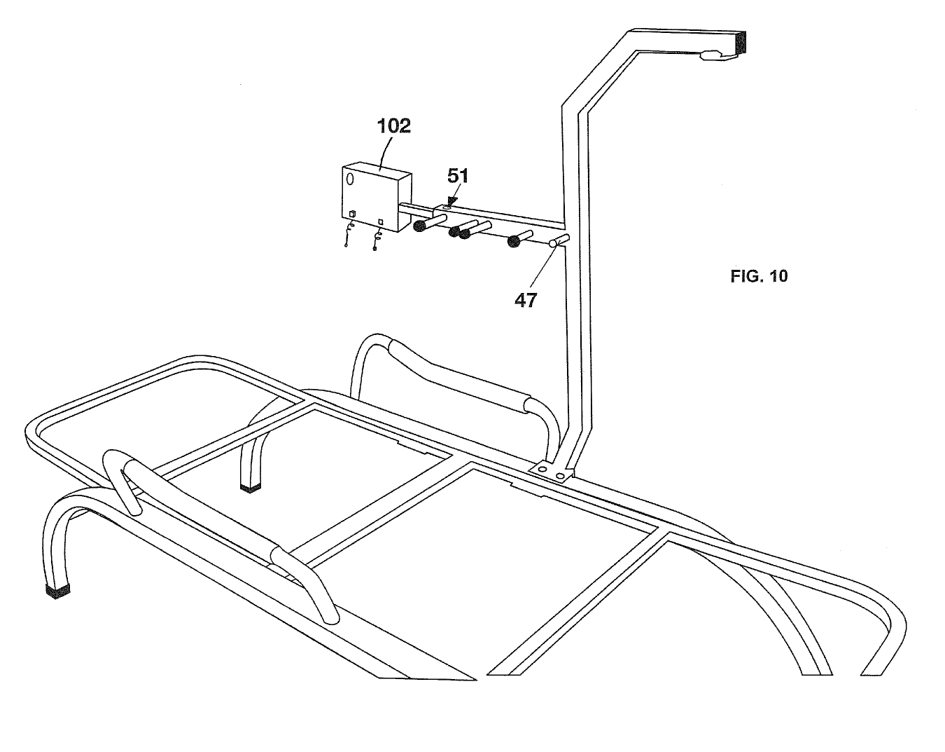

As well, whereas specific treatment appliances and mats are herein shown and described, it will be understood that the invention could readily be used with other energetic medical devices and diagnostic devices, either as substitutes for, or supplemental to, those illustrated and described herein. FIG. 10, for example, shows the accessory bar in use with a diagnostic device 102.

Further, although not shown, the bar could be made telescopic, for greater flexibility.

Also not shown, a credit card reader could be provided and received, for example, in a manner analogous to the manner in which the video monitor is mounted. This would, for example, allow the treatment system to be installed on a pay-per-use basis in airports, hotels, etc.

Accordingly, the present invention should be understood as limited only by the accompanying claims, purposively construed.

1. Apparatus for use with a treatment system of the type including:
a treatment bed, the bed having: one or more cushions for supporting a user in the supine or prone position; a bed frame supporting the one or more cushions in use; a pair of grips, bolted on opposite sides of the bed frame, for assisting the user in movement to and from the supine and prone positions; and a cradle, releasably mounted to the bed frame;
first and second treatment appliances, each appliance including a waisted portion;
a treatment mat having a hand-grip;
a first remote control unit, for controlling the first and second treatment appliances and adapted to be releasably received by the cradle;
a second remote control unit, for controlling the treatment mat, the second remote control unit having a socket defined therein;
the apparatus comprising:
a support frame, for, in use, releasably receiving and supporting in elevated relation above and to one side of the treatment bed, one or more of: the first treatment appliance, the second treatment appliance, the treatment mat, the first remote control unit, the second remote control unit, the cradle and a video monitor.

2. Apparatus according to claim 1, wherein the support frame is adapted for, in use, releasably receiving and supporting in elevated relation above and to one side of the treatment bed: the first treatment appliance, the second treatment, the treatment mat, the first remote control unit, the second remote control unit and the cradle.

3. Apparatus according to claim 2, wherein the support frame includes an upright having an arm extending laterally therefrom, the arm having:
for each appliance, a pair of protruding posts, the posts of each pair being spaced apart for releasably receiving therebetween the waisted portions of said each appliance, to provide for said releasable receipt of said each appliance.

4. Apparatus according to claim 2, wherein the support arm includes a bore to provide for said releasable receipt of the cradle.

5. Apparatus according to claim 2, wherein the support arm further includes a pin for receiving the socket of the second remote control unit, to provide for said releasable receipt of the second remote control unit.

6. Apparatus according to claim 3, wherein the upright forms part of crook, the crook terminating in a hook for receiving the hand-grip of the treatment mat, to provide for said releasable receipt of the treatment mat.

7. Apparatus according to claim 6, wherein the crook, the upright and the arm are substantially coplanar, with the hook and the arm lying on opposite sides of the upright.

8. Apparatus according to claim 1, wherein the support frame is releasably secured to the bed frame in use.

9. Apparatus according to claim 1, wherein the support frame is bolted to the bed frame in use and one or more of the bolts bolting the support frame to the bed frame form part of the bolts by which the grips are mounted to the bed frame.

10. Apparatus for use with a treatment system of the type including:
a treatment bed, the bed having: a main body cushion for supporting and selectively applying heat and massage to the upper body of a user in the supine or prone position; a lower body cushion for supporting and selectively applying heat and massage to the lower body of the user; a bed frame supporting the main body cushion and the lower body cushion in use; a pair of grips, bolted on opposite sides of the bed frame, for assisting the user in movement to and from the supine and prone positions; and a cradle, releasably mounted to the frame;
first and second treatment appliances, each for placement against a selected body region and selectively applying heat and point pressure thereto, each appliance including a waisted portion;
a treatment mat having a hand-grip and adapted for producing far infrared radiation and negative ions;
a first remote control unit, for controlling the first and second treatment appliances and the main and lower body cushions and adapted to be releasably received by the cradle;
a second remote control unit, for controlling the treatment mat, the second remote control unit having a socket defined therein,
the apparatus comprising:
a support frame, for, in use, releasably receiving and supporting in elevated relation above and to one side of the treatment bed, one or more of: the first treatment appliance, the second treatment appliance, the treatment mat, the first remote control unit, the second remote control unit, the cradle and a video monitor.

11. In combination:
a treatment bed having: one or more cushions for supporting a user in the supine or prone position; and a bed frame supporting the one or more cushions in use; and
a support frame releasably connected, in use, to the treatment bed, and adapted for releasably receiving and supporting in elevated relation above and to one side of the treatment bed, one or more of:
a diagnostic device;
an energetic medical device;
a credit card reader;
a remote control; and
a video monitor.

12. The combination of claim 11, wherein:
the treatment bed has a pair of grips, bolted on opposite sides of the bed frame, for assisting the user in movement to and from the supine and prone positions; and
the support frame is bolted to the bed frame in use and one or more of the bolts bolting the support frame to the bed frame form part of the bolts by which the grips are mounted to the bed frame.

13. Apparatus according to claim 11,
further comprising an energetic medical device having a waisted portion; and
wherein the support frame is adapted for receiving said energetic medical device and includes an upright and, for said energetic medical device, a pair of horizontally extending posts adapted to receive therebetween the waisted portion of said energetic medical device, thereby to provide for said releasably receipt of said energetic medical device.

14. Apparatus according to claim 13, wherein the upright has an arm extending laterally therefrom and from which the posts protrude.

15. Apparatus according to claim 14, wherein the energetic medical device is for placement against a selected body region and selectively applying far infrared radiation and point pressure thereto.

16. Apparatus according to claim 14,
further comprising an energetic medical device having a hand-grip; and
wherein the support frame is adapted for receiving said energetic medical device and wherein the upright forms part of crook, the crook terminating in a hook for receiving the hand-grip of the energetic medical device, to provide for said releasable receipt of said energetic medical device.

17. Apparatus according to claim 16, wherein the energetic medical device is a treatment mat adapted to produce far infrared radiation and negative ions.

18. Apparatus according to claim 17, wherein the crook, the upright and the arm are substantially coplanar, with the hook and the arm lying on opposite sides of the upright.

19. An accessory bar for a treatment bed, the bar comprising:
a bracket releasably mounted, in use, to said treatment bed;
an upright extending upwardly from the bracket in use;
an arm extending transversely from the upright, the arm having extending therefrom one or more pairs of posts, the posts extending generally horizontally, towards the area over the bed, in use.

20. A bar according to claim 19, wherein the upright forms part of crook, the crook terminating in a hook, the crook, the upright and the arm being substantially coplanar, with the hook and the arm lying on opposite sides of the upright.
